(19) United States
(12) Patent Application Publication
(10) Pub. No.: US 2018/0239725 A1
(43) Pub. Date: Aug. 23, 2018

(54) Persistent Remote Direct Memory Access

(71) Applicant: Intel Corporation, Santa Clara, CA (US)

(72) Inventors: Karthik Kumar, Chandler, AZ (US); Suleyman Sair, Phoenix, AZ (US); Francesc Guim Bernat, Barcelona (ES); Thomas Willhalm, Sandhausen (DE); Daniel Rivas Barragan, Cologne (DE)

(73) Assignee: Intel Corporation, Santa Clara, CA (US)

(21) Appl. No.: 15/435,886

(22) Filed: Feb. 17, 2017

(51) Int. Cl. G06F 13/28; G06F 12/0891; G06F 3/06; G06F 13/40

(52) U.S. Cl. CPC G06F 13/28; G06F 12/0891; G06F 3/0619; G06F 3/061; G06F 2212/60; G06F 3/067; G06F 13/4022; G06F 13/4068; G06F 3/0656

(57) ABSTRACT

In an example, there is disclosed a computing apparatus, including: a host fabric interface (HFI) for communicatively coupling to a fabric controller of a fabric; an asynchronous data refresh (ADR) having an auxiliary power and an ADR buffer; and a memory controller including logic to: directly access a persistent fast memory of a remote computing device via the fabric; detect a primary power failure event; and flush data from the ADR buffer to the fabric controller.

### FIELD OF THE SPECIFICATION

This disclosure relates in general to the field of cloud computing, and more particularly, though not exclusively to, a system and method for persistent remote direct memory access

### BACKGROUND

Contemporary computing practice has moved away from hardware-specific computing and toward “the network is the device.” A contemporary network may include a datacenter hosting a large number of generic hardware server devices, contained in a server rack for example, and controlled by a hypervisor. Each hardware device may run one or more instances of a virtual device, such as a workload server or virtual desktop.

In some cases, a virtualized network may also include network function virtualization (NFV), which provides certain network functions as virtual appliances. These functions may be referred to as virtual network functions (VNFs). In the past, the functions provided by these VNFs may have been provided by bespoke hardware service appliances.

Thus, in a contemporary “cloud” architecture, both network endpoints and network infrastructure may be at least partially provided in a virtualization layer.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1a is a block diagram of a network according to one or more examples of the present specification.

FIG. 1b is a block diagram of selected components of a datacenter in the network according to one or more examples of the present specification.

FIG. 2 is a block diagram of selected components of an end-user computing device according to one or more examples of the present specification.

FIG. 3 is a high-level block diagram of a server according to one or more examples of the present specification.

FIG. 4a is a block diagram of software-defined networking (SDN) according to one or more examples of the present specification.

FIG. 4b is a block diagram of network function virtualization (NFV) according to one or more examples of the present specification.

FIG. 5 is a block diagram of a platform architecture according to one or more examples of the present specification.

FIG. 6 is a block diagram of a processor according to one or more examples of the present specification.

FIG. 7 is a block diagram of a datacenter according to one or more examples of the present specification.

FIG. 8 is a signal flow diagram of a remote persistent write according to one or more examples of the present specification.

FIG. 9 is a flow chart of a method performed by a first computing system according to one or more examples of the present specification.

FIG. 10 is a flow chart of a method performed by a switching fabric according to one or more examples of the present specification.

FIG. 11 is a flow chart of a method performed by a second computing system according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Cloud computing and virtualization have led to a situation where a “computer” is hardly recognizable as an individual entity. In a classic architecture, a so-called “Von Neumann” machine had a processor, a memory, input/output (IO) facilities, and (in later usage) a nonvolatile storage. While these essential elements still exist, in contemporary practice, “the datacenter is the computer” in many cases. For example, a processor may, in fact, be a service level agreement (SLA) guaranteeing access to one or more cores from a resource pool for a certain minimum time. The storage may be a virtual disk (VD) with a nominal size that can be elastically resized, and may include an SLA for a certain storage bandwidth and capacity. For a virtual desktop, IO may be handled by a web browser running a virtualization desktop application on a remote terminal such as a bare-bones “Chromebook.” And even memory need not be local to the processor anymore. As datacenter fabric evolves and becomes faster, it has become feasible to have dedicated “memory servers,” with pools of very fast and powerful memory that can be allocated to certain processors.

Recently, Intel® corporation and others have introduced revolutionary memory technologies that further push the boundaries of computing. For example, Intel®'s “3D Crosspoint” (3DXP) provides memory that is, like traditional dynamic random access memory (DRAM), fast (on the order of traditional DRAM) and bit-addressable, but that is also persistent like nonvolatile storage technologies (e.g., hard drives or solid state memory). Stated differently, 3DXP is a “persistent fast memory,” or in other words, memory that is faster than traditional nonvolatile storage, and persistent without the application of power.

This is a leap forward from decades of software relying on a two-tier memory scheme, with fast memory and slow persistent memory. But relying on persistent fast memory for storage also introduces some new complexities. For example, the system cannot simply wait for a “store to memory” (STO) instruction to complete and assume that the data are now persistent. Rather, the store could, in the interim, be sitting somewhere between the volatile caches and memory controller buffers, having not yet reached persistency. As this condition is not visible to the application that issued the STO instruction, the result may be an inconsistent memory state in the case of a primary power loss before a datum achieves persistency.

To address this concern, a system may be provided with a secondary or auxiliary power facility (e.g., a battery or capacitor with sufficient energy reserve to complete a store operation) and an asynchronous data refresh (ADR) buffer. In the event of a primary power loss, the auxiliary power is used to flush data out from cache to the ADR buffer, thus completing the persistent store.

However, with high-speed fabric, even memory may not be local to the processor. Rather, remote direct memory access (RDMA) may be used to access memory on a second machine, which may have a faster or more capable memory, such as persistent fast memory. In the case of RDMA, data hosted on a second device is mapped as though it were local memory, and can be addressed and used as such. Now, in the case of a primary power loss, several pieces come into play. A cached store operation must go from the local cache, out to the switch providing the fabric, and then from the switch to the second device providing the memory. The store is not successfully complete until the data have been written to persistent memory on the second device.

To this end, ADR buffers may be provided on each of device one, the switch, and device two. Now, in the case of a primary power failure, the following sequence of events may occur:
a. Device one has data in cache, which is targeted to persistent fast memory. Using its auxiliary power, device one flushes the data from cache to its local ADR buffer.
b. Using auxiliary power, device one sends the data via the host fabric interface (HFI) from the ADR buffer to the switch. The switch responds with an acknowledgement (ACK), meaning that from the perspective of device one, the write is successful.
c. On the switch, using auxiliary power, the data are received into an ADR buffer. The ADR buffer may itself be nonvolatile (e.g., a dual in-line memory module (DIMM) or nonvolatile memory (NVM) DIMM). Thus, if auxiliary power fails before the transaction is complete, the data are not lost.
d. Once the switch has received the data into its ADR buffer, the switch sends to device one an ACK.
e. The switch now flushes the data out to device two, which has the target persistent fast memory. After sending the data out to device two, the switch receives an ACK from device two, and from the perspective of the switch, the store is successful.
f. If the switch fails to receive an ACK from device two (e.g., auxiliary power fails before the transaction is complete), then the switch may retain the memory and try the write-out again once power is restored, or may take some other action such as notifying a system administrator.
g. On device two, the data are received into the ADR buffer. The data are then flushed to persistent fast memory, and device two sends an ACK to the switch. The data are now persistently stored, and may be recovered when primary power is restored.

In describing the present architecture, the following non-exhaustive and nonlimiting list of definitions may be beneficial.

caching agents (CA) are the coherency agents within a node that process memory requests from the cores within the same node. In current architectures, cores use the super queue (SQ) structure to store on-die interconnect requests that are sent to the CA (e.g., all the different loads that the core sends to the CA).

Home agents (HA) are the node clusters that are responsible for processing memory requests from the caching agents, and act as a “home” for part of the memory address space (one die can have multiple homes having a distributed address space mapping). Depending on the address space the requests are targeting, they may go to the same node's local memory, they may go the Ultra Path Interconnect (UPI) agent (formerly called QPI or KTI) to route the request to the other processors within the same coherent domain, or they may go through the HFI to structures that are outside the coherent domain. All the processors connected through UPI belong to the same coherent domain. One system can include one or more coherent domains, with all the coherent domains connected through fabric interconnect. For example, high performance computing (HPC) or datacenters include N clusters or servers that can communicate with each other using the fabric. Using the fabric (such as STL), each coherent domain can expose some address regions to the other coherent domains. The HFI may provide access to traditional node architectures and may provide access to newer types of resources, such as pooled resources and accelerators.

A system and method for persistent remote direct memory access will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

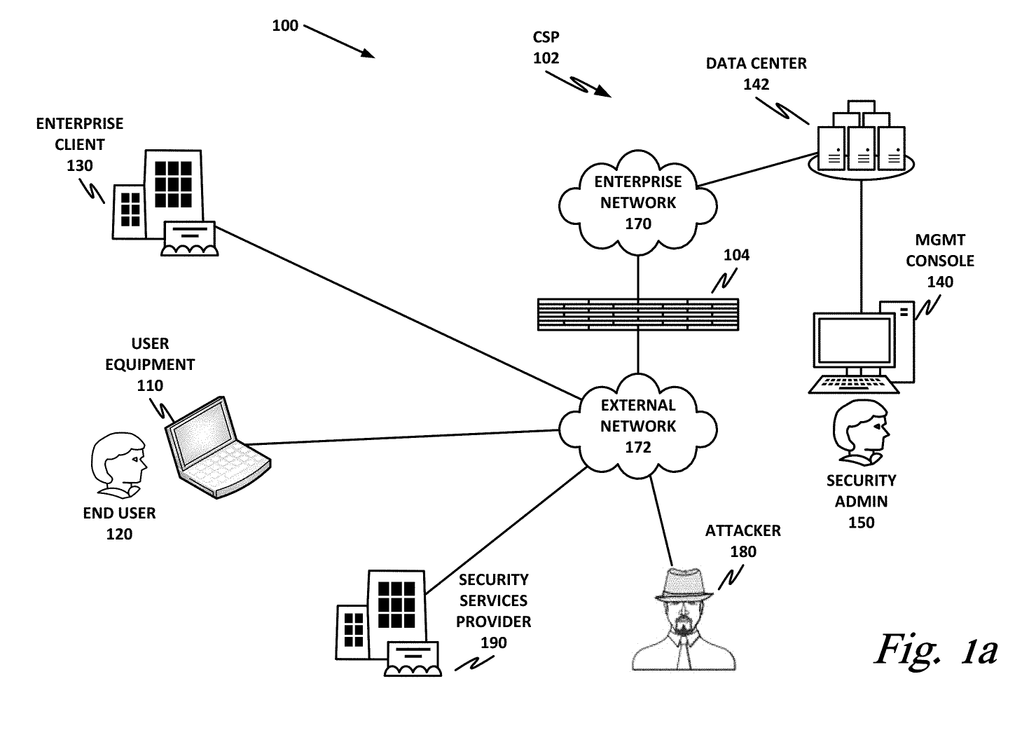

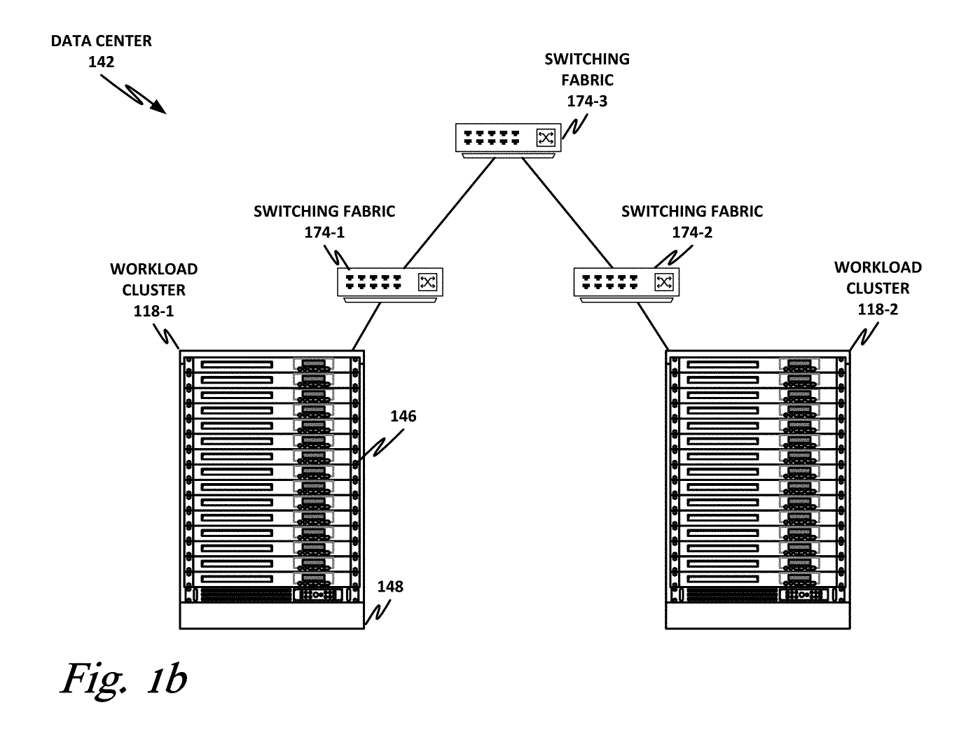

FIG. 1a is a network-level diagram of a network 100 of a cloud service provider (CSP) 102 according to one or more examples of the present specification. In the example of FIG. 1a, network 100 may be configured to enable one or more enterprise clients 130 to provide services or data to one or more end users 120, who may operate user equipment 110 to access information or services via external network 172. This example contemplates an embodiment in which a cloud service provider 102 is itself an enterprise that provides third-party “network as a service” (NaaS) to enterprise client 130. However, this example is nonlimiting. Enterprise client 130 and CSP 102 could also be the same or a related entity in appropriate embodiments.

Enterprise network 170 may be any suitable network or combination of one or more networks operating on one or more suitable networking protocols, including, for example, a fabric, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices, which in an example may be virtualized within datacenter 142. In this illustration, enterprise network 170 is shown as a single network for simplicity, but in some embodiments, enterprise network 170 may include a large number of networks, such as one or more enterprise intranets connected to the Internet, and may include datacenters in a plurality of geographic locations. Enterprise network 170 may also provide access to an external network, such as the Internet, via external network 172. External network 172 may similarly be any suitable type of network.

A datacenter 142 may be provided, for example as a virtual cluster running in a hypervisor on a plurality of rackmounted blade servers, or as a cluster of physical servers. Datacenter 142 may provide one or more server functions, one or more VNFs, or one or more “microclouds” to one or more tenants in one or more hypervisors. For example, a virtualization environment such as vCenter may provide the ability to define a plurality of “tenants,” with each tenant being functionally separate from each other tenant, and each tenant operating as a single-purpose microcloud. Each microcloud may serve a distinctive function, and may include a plurality of virtual machines (VMs) of many different flavors. In some embodiments, datacenter 142 may also provide multitenancy, in which a single instance of a function may be provided to a plurality of tenants, with data for each tenant being insulated from data for each other tenant.

It should also be noted that some functionality of user equipment 110 may also be provided via datacenter 142. For example, one microcloud may provide a remote desktop hypervisor such as a Citrix workspace, which allows end users 120 to remotely log in to a remote enterprise desktop and access enterprise applications, workspaces, and data. In that case, UE 110 could be a “thin client” such as a Google Chromebook, running only a stripped-down operating system, and still provide user 120 useful access to enterprise resources.

One or more computing devices configured as a management console 140 may also operate on enterprise network 170. Management console 140 may be a special case of user equipment, and may provide a user interface for a security administrator 150 to define enterprise security and network policies, which management console 140 may enforce on enterprise network 170 and across client devices 110 and datacenter 142. In an example, management console 140 may run a server-class operating system, such as Linux, Unix, or Windows Server. In another case, management console 140 may be provided as a web interface, on a desktop-class machine, or via a VM provisioned within datacenter 142.

Network 100 may communicate across enterprise boundary 104 with external network 172. Enterprise boundary 104 may represent a physical, logical, or other boundary. External network 172 may include, for example, websites, servers, network protocols, and other network-based services. CSP 102 may also contract with a third-party security services provider 190, such as McAfee® or another security services enterprise, to provide security services to network 100.

It may be a goal of enterprise clients to securely provide network services to end users 120 via datacenter 142, as hosted by CSP 102. To that end, CSP 102 may provide certain contractual quality of service (QoS) guarantees and/or service level agreements (SLAs). QoS may be a measure of resource performance, and may include factors such as availability, jitter, bit rate, throughput, error rates, and latency, to name just a few. An SLA may be a contractual agreement that may include QoS factors, as well as factors such as “mean time to recovery” (MTTR) and mean time between failure (MTBF). In general, an SLA may be a higher-level agreement that is more relevant to an overall experience, whereas QoS may be used to measure the performance of individual components. However, this should not be understood as implying a strict division between QoS metrics and SLA metrics.

Turning to FIG. 1b, to meet contractual QoS and SLA requirements, CSP 102 may provision some number of workload clusters 118. In this example, two workload clusters, 118-1 and 118-2 are shown, each providing up to 16 rackmount servers 146 in a chassis 148. These server racks may be collocated in a single datacenter, or may be located in different geographic datacenters. Depending on the contractual agreements, some servers 146 may be specifically dedicated to certain enterprise clients or tenants, while others may be shared.

Selection of a number of servers to provision in a datacenter is a nontrivial exercise for CSP 102. CSP 102 may wish to ensure that there are enough servers to handle network capacity, and to provide for anticipated device failures over time. However, provisioning too many servers 146 can be costly both in terms of hardware cost, and in terms of power consumption. Thus, ideally, CSP 102 provisions enough servers 146 to service all of its enterprise clients 130 and meet contractual QoS and SLA benchmarks, but not have wasted capacity.

The various devices in datacenter 142 may be connected to each other via a switching fabric 174, which may include one or more high speed routing and/or switching devices. In some cases, switching fabric 174 may be hierarchical, with, for example, switching fabric 174-1 handling workload cluster 118-1, switching fabric 174-2 handling workload cluster 118-2, and switching fabric 174-3. This simple hierarchy is shown to illustrate the principle of hierarchical switching fabrics, but it should be noted that this may be significantly simplified compared to real-life deployments. In many cases, the hierarchy of switching fabric 174 may be multifaceted and much more involved. Common network architectures include hub-and-spoke architectures and leaf-spine architectures.

The fabric itself may be provided by any suitable interconnect, such as Intel® OmniPath™, TrueScale™, Ultra Path Interconnect (UPI) (formerly called QPI or KTI), STL, Ethernet, PCI, or PCIe, to name just a few. Some of these will be more suitable for certain types of deployments than others, and selecting an appropriate fabric for the instant application is an exercise of ordinary skill.

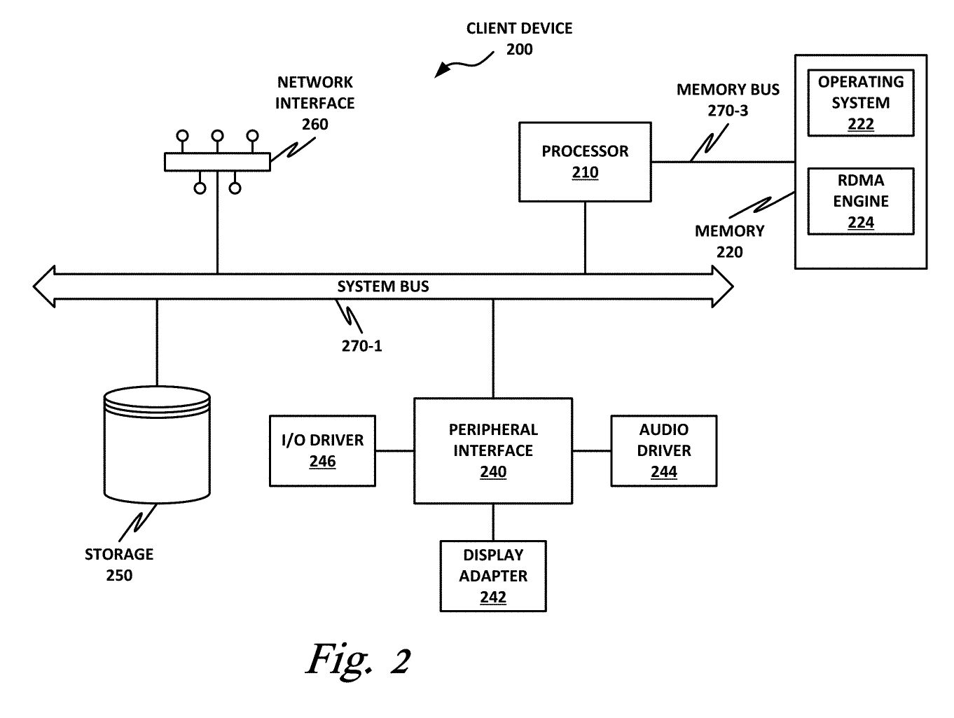

FIG. 2 is a block diagram of client device 200 according to one or more examples of the present specification. Client device 200 may be any suitable computing device. In various embodiments, a “computing device” may be or comprise, by way of nonlimiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it may be designated as a “remote host.” In particular, user equipment 110 may be a client device 200, and in one particular example, client device 200 is a virtual machine configured for RDMA as described herein.

Client device 200 includes a processor 210 connected to a memory 220, having stored therein executable instructions for providing an operating system 222 and at least software portions of remote direct memory access (RDMA) engine 224. Other components of client device 200 include a storage 250, network interface 260, and peripheral interface 240. This architecture is provided by way of example only, and is intended to be nonexclusive and nonlimiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices, such as in the case of a datacenter storage pool or memory server. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block.

As used throughout this specification, “logic elements” may include hardware (including, for example, a programmable software, application-specific integrated circuit (ASIC), or field-programmable gate array (FPGA)), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, nontransitory computer-readable medium having stored thereon executable instructions for instructing a processor to perform a certain task. Such a nontransitory medium could include, for example, a hard disk, solid state memory or disk, read-only memory (ROM), persistent fast memory (PFM) (e.g., Intel® 3D Crosspoint), external storage, redundant array of independent disks (RAID), redundant array of independent nodes (RAIN), network-attached storage (NAS), optical storage, tape drive, backup system, cloud storage, or any combination of the foregoing by way of nonlimiting example. Such a medium could also include instructions programmed into an FPGA, or encoded in hardware on an ASIC or processor.

In an example, processor 210 is communicatively coupled to memory 220 via memory bus 270-3, which may be, for example, a direct memory access (DMA) bus, by way of example. However, other memory architectures are possible, including ones in which memory 220 communicates with processor 210 via system bus 270-1 or some other bus. In datacenter environments, memory bus 270-3 may be, or may include, the fabric.

Processor 210 may be communicatively coupled to other devices via a system bus 270-1. As used throughout this specification, a “bus” includes any wired or wireless interconnection line, network, connection, fabric, bundle, single bus, multiple buses, crossbar network, single-stage network, multistage network, or other conduction medium operable to carry data, signals, or power between parts of a computing device, or between computing devices. It should be noted that these uses are disclosed by way of nonlimiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including, by way of nonlimiting example, a microprocessor, digital signal processor (DSP), field-programmable gate array (FPGA), graphics processing unit (GPU), programmable logic array (PLA), application-specific integrated circuit (ASIC), or virtual machine processor. In certain architectures, a multicore processor may be provided, in which case processor 210 may be treated as only one core of a multicore processor, or may be treated as the entire multicore processor, as appropriate. In some embodiments, one or more coprocessors may also be provided for specialized or support functions.

Processor 210 may be connected to memory 220 in a DMA configuration via bus 270-3. To simplify this disclosure, memory 220 is disclosed as a single logical block, but in a physical embodiment may include one or more blocks of any suitable volatile or nonvolatile memory technology or technologies, including, for example, double data rate random access memory (DDR RAM), static random access memory (SRAM), dynamic random access memory (DRAM), persistent fast memory (PFM) (such as Intel® 3D Crosspoint (3DXP)), cache, L1 or L2 memory, on-chip memory, registers, flash, ROM, optical media, virtual memory regions, magnetic or tape memory, or similar. Memory 220 may be provided locally, or may be provided elsewhere, such as in the case of a datacenter with a 3DXP memory server. In certain embodiments, memory 220 may comprise a relatively low-latency volatile main memory, while storage 250 may comprise a relatively higher-latency nonvolatile memory. However, memory 220 and storage 250 need not be physically separate devices, and in some examples may represent simply a logical separation of function. These lines can be particularly blurred in cases where the only long-term memory is a battery-backed RAM, or where the main memory is provided as PFM. It should also be noted that although DMA is disclosed by way of nonlimiting example, DMA is not the only protocol consistent with this specification, and that other memory architectures are available.

Operating system 222 may be provided, though it is not necessary in all embodiments. For example, some embedded systems operate on “bare metal” for purposes of speed, efficiency, and resource preservation. However, in contemporary systems, it is common for even minimalist embedded systems to include some kind of operating system. Where it is provided, operating system 222 may include any appropriate operating system, such as Microsoft Windows, Linux, Android, Mac OSX, Apple iOS, Unix, or similar. Some of the foregoing may be more often used on one type of device than another. For example, desktop computers or engineering workstations may be more likely to use one of Microsoft Windows, Linux, Unix, or Mac OSX. Laptop computers, which are usually a portable off-the-shelf device with fewer customization options, may be more likely to run Microsoft Windows or Mac OSX. Mobile devices may be more likely to run Android or iOS. Embedded devices often use an embedded Linux or a dedicated embedded OS such as VxWorks. However, these examples are not intended to be limiting.

Storage 250 may be any species of memory 220, or may be a separate nonvolatile memory device. Storage 250 may include one or more nontransitory computer-readable mediums, including, by way of nonlimiting example, a hard drive, solid-state drive, external storage, redundant array of independent disks (RAID), redundant array of independent nodes (RAIN), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of RDMA engine 224. In some examples, storage 250 may be a nontransitory computer-readable storage medium that includes hardware instructions or logic encoded as processor instructions or on an ASIC. Many other configurations are also possible, and are intended to be encompassed within the broad scope of this specification.

Network interface 260 may be provided to communicatively couple client device 200 to a wired or wireless network. A “network,” as used throughout this specification, may include any communicative platform or medium operable to exchange data or information within or between computing devices, including, by way of nonlimiting example, Ethernet, WiFi, a fabric, an ad-hoc local network, an Internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment. Note that in certain embodiments, network interface 260 may be, or may include, a host fabric interface (HFI).

RDMA engine 224, in one example, is operable to carry out computer-implemented methods as described in this specification. RDMA engine 224 may include one or more tangible nontransitory computer-readable mediums having stored thereon executable instructions operable to instruct a processor to provide an RDMA engine 224. RDMA engine 224 may also include a processor, with corresponding memory instructions that instruct the processor to carry out the desired method. As used throughout this specification, an “engine” includes any combination of one or more logic elements, of similar or dissimilar species, operable for and configured to perform one or more methods or functions of the engine. In some cases, RDMA engine 224 may include a special integrated circuit designed to carry out a method or a part thereof, and may also include software instructions operable to instruct a processor to perform the method. In some cases, RDMA engine 224 may run as a “daemon” process. A “daemon” may include any program or series of executable instructions, whether implemented in hardware, software, firmware, or any combination thereof that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space” associated with ring 0, 1, or 2 in a protection ring architecture. It should be noted that RDMA engine 224 may also include other hardware and software, including configuration files, registry entries, and interactive or user-mode software by way of nonlimiting example.

In one example, RDMA engine 224 includes executable instructions stored on a nontransitory medium operable to perform a method according to this specification. At an appropriate time, such as upon booting client device 200 or upon a command from operating system 222 or a user 120, processor 210 may retrieve a copy of the instructions from storage 250 and load it into memory 220. Processor 210 may then iteratively execute the instructions of RDMA engine 224 to provide the desired method.

Peripheral interface 240 may be configured to interface with any auxiliary device that connects to client device 200 but that is not necessarily a part of the core architecture of client device 200. A peripheral may be operable to provide extended functionality to client device 200, and may or may not be wholly dependent on client device 200. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of nonlimiting example.

In one example, peripherals include display adapter 242, audio driver 244, and input/output (IO) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of nonlimiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of nonlimiting example. Note that in embodiments where client device 200 is a virtual machine, peripherals may be provided remotely by a device used to access the virtual machine.

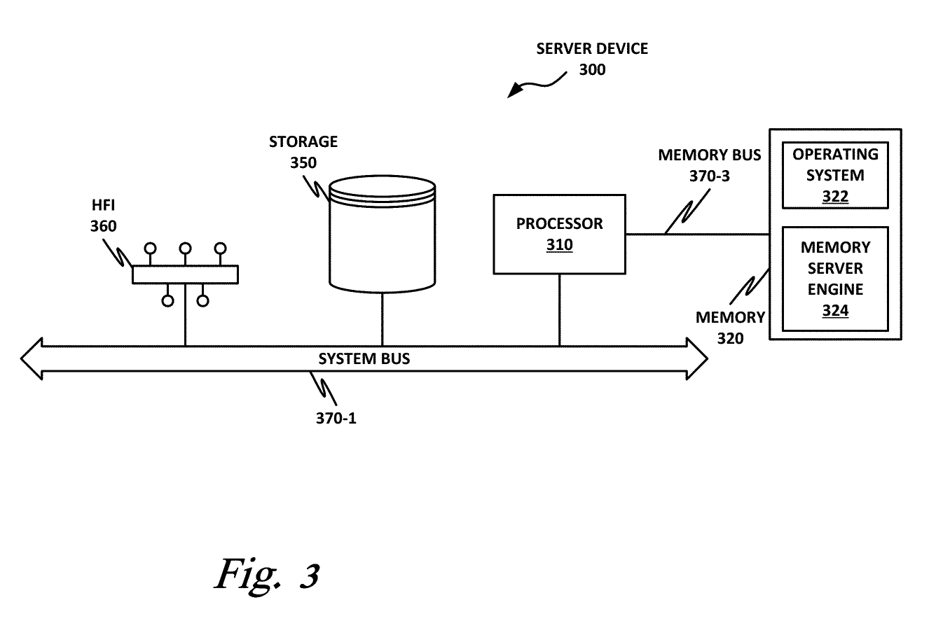

FIG. 3 is a block diagram of a server-class device 300 according to one or more examples of the present specification. Server 300 may be any suitable computing device, as described in connection with FIG. 2. In general, the definitions and examples of FIG. 2 may be considered as equally applicable to FIG. 3, unless specifically stated otherwise. Server 300 is described herein separately to illustrate that in certain embodiments, logical operations may be divided along a client-server model, wherein client device 200 provides certain localized tasks, while server 300 provides certain other centralized tasks.

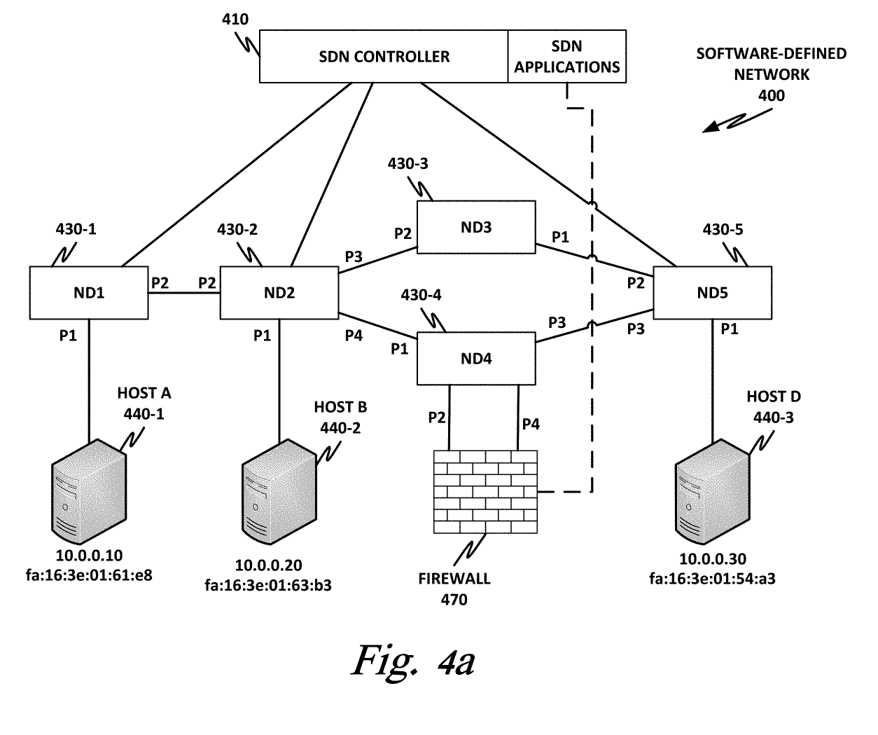

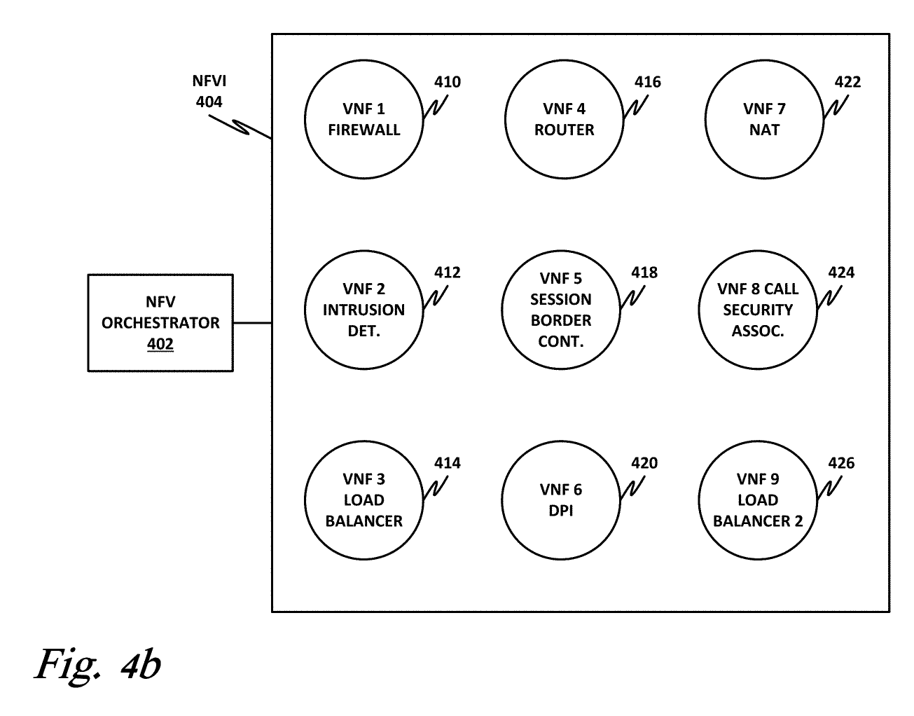

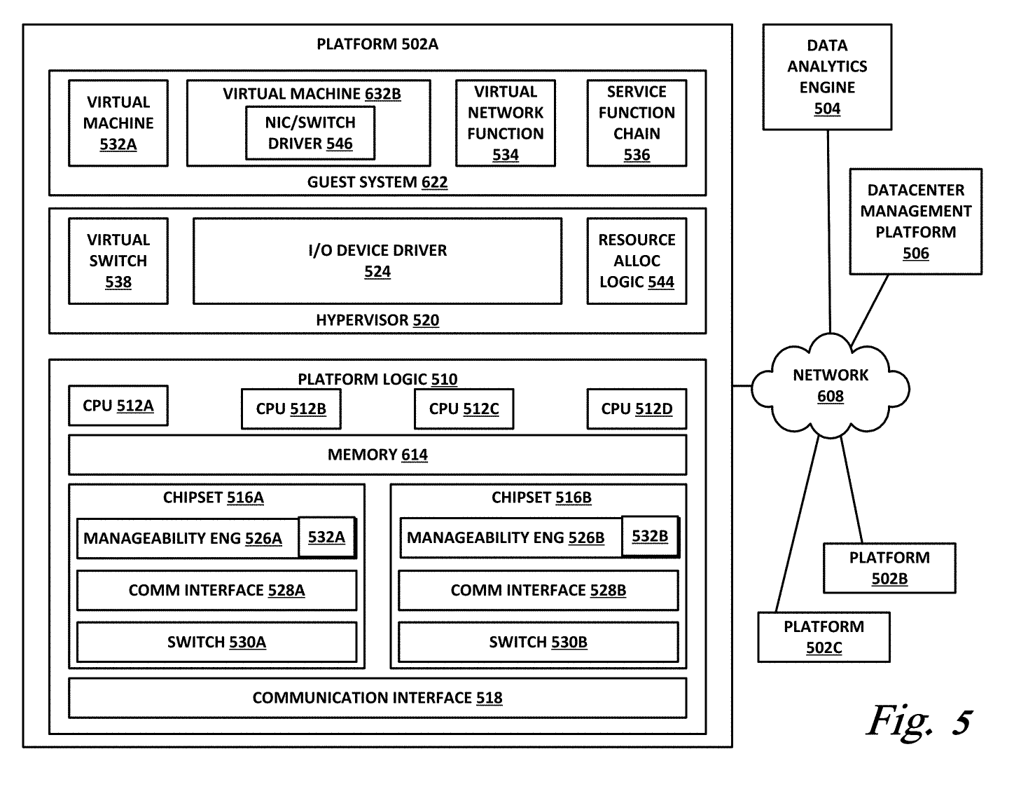

Note that server 300 of FIG. 3 illustrates in particular the classic “Von Neumann Architecture” aspects of server 300, with a focus on functional blocks. Other FIGURES herein (e.g., FIGS. 4a, 4b, and 5 below) may illustrate other aspects of a client or server device, with more focus on virtualization aspects. These illustrated embodiments are not intended to be mutually exclusive or to infer a necessary distinction. Rather, the various views and diagrams are intended to illustrate different perspectives and aspects of these devices.

In a particular example, server device 300 may be a memory server as illustrated herein.

Server 300 includes a processor 310 connected to a memory 320, having stored therein executable instructions for providing an operating system 322 and at least software portions of a memory server engine 324. Other components of server 300 include a storage 350, and host fabric interface 360. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type. Memory 320 may include a persistent fast memory, such as 3DXP or similar.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of memory server engine 324.

Host fabric interface 360 may be provided to communicatively couple server 300 to a wired or wireless network, including a host fabric. A host fabric may include a switched interface for communicatively coupling nodes in a cloud or cloud-like environment. HFI 360 is used by way of example here, though any other suitable network interface (as discussed in connection with network interface 260) may be used.

Memory server engine 324 is an engine as described in FIG. 2 and, in one example, includes one or more logic elements operable to carry out computer-implemented methods as described in this specification. Software portions of memory server engine 324 may run as a daemon process.

Memory server engine 324 may include one or more nontransitory computer-readable mediums having stored thereon executable instructions operable to instruct a processor to provide memory server engine 324. At an appropriate time, such as upon booting server 300 or upon a command from operating system 322 or a user 120 or security administrator 150, processor 310 may retrieve a copy of memory server engine 324 (or software portions thereof) from storage 350 and load it into memory 320. Processor 310 may then iteratively execute the instructions of memory server engine 324 to provide the desired method.

FIG. 4a is a block diagram of a software-defined network 400. In software defined networking (SDN), a data plane is separated from a control plane to realize certain advantages. SDN is only one flavor of virtualization, shown here to illustrate one option for a network setup.

Network function virtualization, illustrated in FIG. 4b, is a second nonlimiting flavor of network virtualization, often treated as an add-on or improvement to SDN, but sometimes treated as a separate entity. NFV was originally envisioned as a method for providing reduced capital expenditure (Capex) and operating expenses (Opex) for telecommunication services, which relied heavily on fast, single purpose service appliances. One important feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, virtual network functions (VNFs) can be provisioned (“spun up”) or removed (“spun down”) to meet network demands. For example, in times of high load, more load balancer VNFs may be spun up to distribute traffic to more workload servers (which may themselves be virtual machines). In times where more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI). Often, the VNFs are in-line service functions that are separate from workload servers or other nodes (in many cases, workload-type functions were long since virtualized). These VNFs can be chained together into a service chain, which may be defined by a virtual subnetwork, and which may include a serial string of network services that provide behind-the-scenes work, such as security, logging, billing, and similar. In one example, an incoming packet passes through a chain of services in a service chain, with one or more of the services being provided by a VNF, whereas historically each of those functions may have been provided by bespoke hardware in a physical service appliance. Because NFVs can be spun up and spun down to meet demand, the allocation of hardware and other resources can be made more efficient. Processing resources can be allocated to meet the greatest demand, whereas with physical service appliances, any unused capacity on an appliance is simply wasted, and increasing capacity to meet demand required plugging in a physical (expensive) bespoke service appliance.

The illustrations of this in FIGS. 4a and 4b may be considered more functional, while in comparison the illustration of FIG. 1 may be more of a high-level logical layout of the network. It should be understood, however, that SDN 400 (FIG. 4a), NFVI 404 (FIG. 4b), and enterprise network 100 may be the same network, or may be separate networks.

In FIG. 4a, SDN 400 may include an SDN controller 410, a plurality of network devices 430, and a plurality of host devices 440. Some or all of SDN controller 410, network devices 430, and host devices 440 may be embodied within workload cluster 142 of FIG. 1, or may otherwise form a part of enterprise network 170.

SDN 400 is controlled by an SDN controller 410. SDN controller 410 is communicatively coupled to a plurality of network devices 430. Specifically, ND1 430-1, ND2 430-2, and ND5 430-5 are directly communicatively coupled to SDN controller 410. Network devices and ND3 430-3 and ND4 430-4 are not directly coupled to SDN controller 410, but rather coupled via the intermediate devices, such as ND2 430-2, and ND5 430-5.

Some network devices 430 also communicatively couple directly to host devices 440. Specifically, network device ND1 directly couples to host A 440-1, which has IP address 10.0.0.10, and MAC address FA:16:3:01:61:8. Network device ND2 430-2 directly couples to host B 440-2, which has IP address 10.0.0.20, and MAC address FA:16:3:01:63: B3. Network device ND5 430-5 directly couples to host D 440-3, which has IP address 10.0.0.30, and MAC address FA:16:3:01:54:83.

Network devices 430 may be configured to perform a variety of network functions, such as, by way of nonlimiting example, load-balancing, firewall, deep packet inspection (DPI), DNS, antivirus, or any other suitable network function. The particular arrangement of interconnections between network devices 430 and from network devices 430 to host devices 440 may be determined by the particular network configuration and needs. Thus, the specific configuration of FIG. 4a should be understood to be an illustrative example only.

Each network device 430 may have a plurality of ingress and or egress interfaces, such as physical Ethernet or fabric ports. In an example, each interface may have a label or new name, such as P1, P2, P3, P4, P5, and so on. Thus, certain aspects of the network layout can be determined by inspecting which devices are connected on which interface. For example, network device ND1 430-1 has an ingress interface for receiving instructions and communicating with SDN controller 410. ND1 430-1 also has an interface P1 communicatively coupled to host A 440-1. ND1 430-1 has interface P2 that is communicatively coupled to ND2 430-2. In the case of ND2 430-2, it also couples to ND1 430-1 on its own interface P2, and couples to host B 440-2 via interface P1. ND2 430-2 communicatively couples to intermediate devices ND3 430-3 and ND4 430-4 via interfaces P3 and P4 respectively. Additional interface definitions are visible throughout the figure.

A flow table may be defined for traffic as it flows from one interface to another. This flow table is used so that a network device, such as ND2 430-2 can determine, after receiving a packet, where to send it next.

For example, the following flow tables may be defined for ND1 430-1-ND4 430-4.

TABLE 1
ND1 Flow Rule

| Ingress | Source | | Source | | |
|---|---|---|---|---|---|
| I/F | MAC | Destination Mac | IP | Dest. IP | Action |
| P1 | ANY | fa:16:3e:01:54:a3 | ANY | 10.0.0.30 | P2 |

TABLE 2
ND2 Flow Rule

| Ingress | Source | | Source | | |
|---|---|---|---|---|---|
| I/F | MAC | Destination Mac | IP | Dest. IP | Action |
| P2 | ANY | fa:16:3e:01:54:a3 | ANY | 10.0.0.30 | P4 |

TABLE 3
ND3 Flow Rule

| Ingress | Source | | Source | | |
|---|---|---|---|---|---|
| I/F | MAC | Destination Mac | IP | Dest. IP | Action |
| P1 | ANY | fa:16:3e:01:54:a3 | ANY | 10.0.0.30 | P3 |

TABLE 4
ND4 Flow Rule

| Ingress | Source | | Source | | |
|---|---|---|---|---|---|
| I/F | MAC | Destination Mac | IP | Dest. IP | Action |
| P3 | ANY | fa:16:3e:01:54:a3 | ANY | 10.0.0.30 | P1 |

FIG. 4b is a block diagram of a network function virtualization (NFV) architecture according to one or more examples of the present specification. Like SDN, NFV is a subset of network virtualization. Thus, the network as illustrated in FIG. 4b may be defined instead of or in addition to the network of FIG. 4a. In other words, certain portions of the network may rely on SDN, while other portions (or the same portions) may rely on NFV.

In the example of FIG. 4b, an NFV orchestrator 402 manages a number of the VNFs running on in an NFVI 404. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus the need for NFV orchestrator 402.

Note that NFV orchestrator 402 itself is usually virtualized (rather than a special-purpose hardware appliance). NFV orchestrator 402 may be integrated within an existing SDN system, wherein an operations support system (OSS) manages the SDN. This may interact with cloud resource management systems (e.g., OpenStack) to provide NFV orchestration. There are many commercially-available, off-the-shelf, proprietary, and open source solutions for NFV orchestration and management (sometimes referred to as NFV MANO). In addition to NFV orchestrator 402, NFV MANO may also include functions such as virtualized infrastructure management (VIM) and a VNF manager.

An NFVI 404 may include the hardware, software, and other infrastructure to enable VNFs to run. This may include, for example, a rack or several racks of blade or slot servers (including, e.g., processors, memory, and storage), one or more datacenters, other hardware resources distributed across one or more geographic locations, hardware switches, network interfaces. An NFVI 404 may also include the software architecture that enables hypervisors to run and be managed by NFV orchestrator 402. NFVI 402 may include NFVI points of presence (NFVI-PoPs), where VNFs are deployed by the operator.

Running on NFVI 404 are a number of virtual machines, each of which in this example is a VNF providing a virtual service appliance. These include, as nonlimiting and illustrative examples, VNF 1 410, which is a firewall, VNF 2 412, which is an intrusion detection system, VNF 3 414, which is a load balancer, VNF 4 416, which is a router, VNF 5 418, which is a session border controller, VNF 6 420, which is a deep packet inspection (DPI) service, VNF 7 422, which is a network address translation (NAT) module, VNF 8 424, which provides call security association, and VNF 9 426, which is a second load balancer spun up to meet increased demand.

Firewall 410 is a security appliance that monitors and controls the traffic (both incoming and outgoing), based on matching traffic to a list of “firewall rules.” Firewall 410 may be a barrier between a relatively trusted (e.g., internal) network, and a relatively untrusted network (e.g., the Internet). Once traffic has passed inspection by firewall 410, it may be forwarded to other parts of the network.

Intrusion detection 412 monitors the network for malicious activity or policy violations. Incidents may be reported to security administrator 150, or collected and analyzed by a security information and event management (SIEM) system. In some cases, intrusion detection 412 may also include antivirus or antimalware scanners.

Load balancers 414 and 426 may farm traffic out to a group of substantially identical workload servers to distribute the work in a fair fashion. In one example, a load balancer provisions a number of traffic “buckets,” and assigns each bucket to a workload server. Incoming traffic is assigned to a bucket based on a factor, such as a hash of the source IP address. Because the hashes are assumed to be fairly evenly distributed, each workload server receives a reasonable amount of traffic.

Router 416 forwards packets between networks or subnetworks. For example, router 416 may include one or more ingress interfaces, and a plurality of egress interfaces, with each egress interface being associated with a resource, subnetwork, virtual private network, or other division. When traffic comes in on an ingress interface, router 416 determines what destination it should go to, and routes the packet to the appropriate egress interface.

Session border controller 418 controls voice over IP (VoIP) signaling, as well as the media streams to set up, conduct, and terminate calls. In this context, “session” refers to a communication event (e.g., a “call”). “Border” refers to a demarcation between two different parts of a network (similar to a firewall).

DPI appliance 420 provides deep packet inspection, including examining not only the header, but also the content of a packet to search for potentially unwanted content (PUC), such as protocol non-compliance, malware, viruses, spam, or intrusions.

NAT module 422 provides network address translation services to remap one IP address space into another (e.g., mapping addresses within a private subnetwork onto the larger Internet).

Call security association 424 creates a security association for a call or other session (see session border controller 418 above). Maintaining this security association may be critical, as the call may be dropped if the security association is broken.

The illustration of FIG. 4 shows that a number of VNFs have been provisioned and exist within NFVI 404. This figure does not necessarily illustrate any relationship between the VNFs and the larger network.

FIG. 5 illustrates a block diagram of components of a computing platform 500 according to one or more examples of the present specification. In the embodiment depicted, computer platform 500 includes a plurality of platforms 502 and system management platform 506 coupled together through network 508. In other embodiments, a computer system may include any suitable number of (i.e., one or more) platforms. In some embodiments (e.g., when a computer system only includes a single platform), all or a portion of the system management platform 506 may be included on a platform 502. A platform 502 may include platform logic 510 with one or more central processing units (CPUs) 512, memories 514 (which may include any number of different modules), chipsets 516, communication interfaces 518, and any other suitable hardware and/or software to execute a hypervisor 520 or other operating system capable of executing workloads associated with applications running on platform 502. In some embodiments, a platform 502 may function as a host platform for one or more guest systems 522 that invoke these applications. Platform 500 may represent any suitable computing environment, such as a high-performance computing environment, a datacenter, a communications service provider infrastructure (e.g., one or more portions of an evolved packet core), an in-memory computing environment, a computing system of a vehicle (e.g., an automobile or airplane), an Internet of Things environment, an industrial control system, other computing environment, or combination thereof.

In various embodiments of the present disclosure, accumulated stress and/or rates of stress accumulated to a plurality of hardware resources (e.g., cores and uncores) are monitored and entities (e.g., system management platform 506, hypervisor 520, or other operating system) of computer platform 500 may assign hardware resources of platform logic 510 to perform workloads in accordance with the stress information. For example, system management platform 506, hypervisor 520 or other operating system, or CPUs 512 may determine one or more cores to schedule a workload onto based on the stress information. In some embodiments, self-diagnostic capabilities may be combined with the stress monitoring to more accurately determine the health of the hardware resources. Such embodiments may allow optimization in deployments including network function virtualization (NFV), software defined networking (SDN), or mission critical applications. For example, the stress information may be consulted during the initial placement virtual network functions (VNFs), or for migration from one platform to another in order to improve reliability and capacity utilization.

Each platform 502 may include platform logic 510. Platform logic 510 comprises, among other logic, enabling the functionality of platform 502, one or more CPUs 512, memory 514, one or more chipsets 516, and communication interface 518. Although three platforms are illustrated, computer platform 500 may include any suitable number of platforms. In various embodiments, a platform 502 may reside on a circuit board that is installed in a chassis, rack, or other suitable structure that comprises multiple platforms coupled together through network 508 (which may comprise, e.g., a rack or backplane switch).

CPUs 512 may each comprise any suitable number of processor cores and supporting logic (e.g., uncores). The cores may be coupled to each other, to memory 514, to at least one chipset 516, and/or to communication interface 518, through one or more controllers residing on CPU 612 and/or chipset 516. In particular embodiments, a CPU 612 is embodied within a socket that is permanently or removably coupled to platform 502. CPU 612 is described in further detail below in connection with FIG. 2. Although four CPUs are shown, a platform 502 may include any suitable number of CPUs.

Memory 514 may comprise any form of volatile or nonvolatile memory, including, without limitation, magnetic media (e.g., one or more tape drives), optical media, random access memory (RAM), read-only memory (ROM), flash memory, removable media, or any other suitable local or remote memory component or components. Memory 514 may be used for short, medium, and/or long term storage by platform 502. Memory 514 may store any suitable data or information utilized by platform logic 510, including software embedded in a computer readable medium, and/or encoded logic incorporated in hardware or otherwise stored (e.g., firmware). Memory 514 may store data that is used by cores of CPUs 512. In some embodiments, memory 514 may also comprise storage for instructions that may be executed by the cores of CPUs 512 or other processing elements (e.g., logic resident on chipsets 516) to provide functionality associated with the manageability engine 526 or other components of platform logic 510. Additionally or alternatively, chipsets 516 may each comprise memory that may have any of the characteristics described herein with respect to memory 514. Memory 514 may also store the results and/or intermediate results of the various calculations and determinations performed by CPUs 512 or processing elements on chipsets 516. In various embodiments, memory 514 may comprise one or more modules of system memory coupled to the CPUs through memory controllers (which may be external to or integrated with CPUs 512). In various embodiments, one or more particular modules of memory 514 may be dedicated to a particular CPU 612 or other processing device or may be shared across multiple CPUs 512 or other processing devices.

In various embodiments, memory 514 may store stress information (such as accumulated stress values associated with hardware resources of platform logic 510 in nonvolatile memory, such that when power is lost, the accumulated stress values are maintained). In particular embodiments, a hardware resource may comprise nonvolatile memory (e.g., on the same die as the particular hardware resource) for storing the hardware resource's accumulated stress value.

A platform 502 may also include one or more chipsets 516 comprising any suitable logic to support the operation of the CPUs 512. In various embodiments, chipset 516 may reside on the same die or package as a CPU 612 or on one or more different dies or packages. Each chipset may support any suitable number of CPUs 512. A chipset 516 may also include one or more controllers to couple other components of platform logic 510 (e.g., communication interface 518 or memory 514) to one or more CPUs. Additionally or alternatively, the CPUs 512 may include integrated controllers. For example, communication interface 518 could be coupled directly to CPUs 512 via integrated IO controllers resident on each CPU.

In the embodiment depicted, each chipset 516 also includes a manageability engine 526. Manageability engine 526 may include any suitable logic to support the operation of chipset 516. In a particular embodiment, manageability engine 526 (which may also be referred to as an innovation engine) is capable of collecting real-time telemetry data from the chipset 516, the CPU(s) 512 and/or memory 514 managed by the chipset 516, other components of platform logic 510, and/or various connections between components of platform logic 510. In various embodiments, the telemetry data collected includes the stress information described herein.

In various examples, the manageability engine 526 operates as an out-of-band asynchronous compute agent which is capable of interfacing with the various elements of platform logic 510 to collect telemetry data with no or minimal disruption to running processes on CPUs 512. For example, manageability engine 526 may comprise a dedicated processing element (e.g., a processor, controller, or other logic) on chipset 516 which provides the functionality of manageability engine 526 (e.g., by executing software instructions), thus conserving processing cycles of CPUs 512 for operations associated with the workloads performed by the platform logic 510. Moreover, the dedicated logic for the manageability engine 526 may operate asynchronously with respect to the CPUs 512 and may gather at least some of the telemetry data without increasing the load on the CPUs.

The manageability engine 526 may process telemetry data it collects (specific examples of the processing of stress information will be provided herein). In various embodiments, manageability engine 526 reports the data it collects and/or the results of its processing to other elements in the computer system, such as one or more hypervisors 520 or other operating systems and/or system management software (which may run on any suitable logic such as system management platform 506). In some embodiments, the telemetry data is updated and reported periodically to one or more of these entities. In particular embodiments, a critical event such as a core that has accumulated an excessive amount of stress may be reported prior to the normal interval for reporting telemetry data (e.g., a notification may be sent immediately upon detection).

In various embodiments, a manageability engine 526 may include programmable code configurable to set which CPU(s) 512 a particular chipset 516 will manage and/or which telemetry data will be collected.

Chipsets 516 also each include a communication interface 528. Communication interface 528 may be used for the communication of signaling and/or data between chipset 516 and one or more IO devices, one or more networks 508, and/or one or more devices coupled to network 508 (e.g., system management platform 506). For example, communication interface 528 may be used to send and receive network traffic such as data packets. In a particular embodiment, communication interface 528 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 516 (e.g., manageability engine 526 or switch 530) and another device coupled to network 508. In some embodiments, network 508 may comprise a switch with bridging and/or routing functions that is external to the platform 502 and operable to couple various NICs distributed throughout the computer platform 500 (e.g., on different platforms) to each other. In various embodiments, a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interface 528 may allow communication of data (e.g., between the manageability engine 526 and the system management platform 506) associated with management and monitoring functions performed by manageability engine 526. In various embodiments, manageability engine 526 may utilize elements (e.g., one or more NICs) of communication interface 528 to report the telemetry data (e.g., to system management platform 506) in order to reserve usage of NICs of communication interface 518 for operations associated with workloads performed by platform logic 510. In some embodiments, communication interface 528 may also allow IO devices integrated with or external to the platform (e.g., disk drives, other NICs, etc.) to communicate with the CPU cores.

Switch 530 may couple to various ports (e.g., provided by NICs) of communication interface 528 and may switch data between these ports and various components of chipset 516 (e.g., one or more peripheral component interconnect express (PCIe) lanes coupled to CPUs 512). Switch 530 may be a physical or virtual (i.e., software) switch.

Platform logic 510 may include an additional communication interface 518. Similar to communication interface 528, communication interface 518 may be used for the communication of signaling and/or data between platform logic 510 and one or more networks 508 and one or more devices coupled to the network 508. For example, communication interface 518 may be used to send and receive network traffic such as data packets. In a particular embodiment, communication interface 518 comprises one or more physical NICs. These NICs may enable communication between any suitable element of platform logic 510 (e.g., CPUs 512 or memory 514) and another device coupled to network 508 (e.g., elements of other platforms or remote computing devices coupled to network 508 through one or more networks). In particular embodiments, communication interface 518 may allow devices external to the platform (e.g., disk drives, other NICs, etc.) to communicate with the CPU cores. In various embodiments, NICs of communication interface 518 may be coupled to the CPUs through IO controllers (which may be external to or integrated with CPUs 512).

Platform logic 510 may receive and perform any suitable types of workloads. A workload may include any request to utilize one or more resources of platform logic 510, such as one or more cores or associated logic. For example, a workload may comprise a request to instantiate a software component, such as an IO device driver 524 or guest system 522; a request to process a network packet received from a virtual machine 532 or device external to platform 502 (such as a network node coupled to network 508); a request to execute a process or thread associated with a guest system 522, an application running on platform 502, a hypervisor 520 or other operating system running on platform 502; or other suitable processing request.

In various embodiments, platform 502 may execute any number of guest systems 522. A guest system may comprise a single virtual machine (e.g., virtual machine 532a or 532b) or multiple virtual machines operating together (e.g., a virtual network function (VNF) 534 or a service function chain (SFC) 536). As depicted, various embodiments may include a variety of types of guest systems 522 present on the same platform 502.

A virtual machine 532 may emulate a computer system with its own dedicated hardware. A virtual machine 532 may run a guest operating system on top of the hypervisor 520. The components of platform logic 510 (e.g., CPUs 512, memory 514, chipset 516, and communication interface 518) may be virtualized such that it appears to the guest operating system that the virtual machine 532 has its own dedicated components.

A virtual machine 532 may include a virtualized NIC (vNIC), which is used by the virtual machine as its network interface. A vNIC may be assigned a media access control (MAC) address or other identifier, thus allowing multiple virtual machines 532 to be individually addressable in a network.

In some embodiments, a virtual machine 532b may be paravirtualized. For example, the virtual machine 532b may include augmented drivers (e.g., drivers that provide higher performance or have higher bandwidth interfaces to underlying resources or capabilities provided by the hypervisor 520). For example, an augmented driver may have a faster interface to underlying virtual switch 538 for higher network performance as compared to default drivers.

VNF 534 may comprise a software implementation of a functional building block with defined interfaces and behavior that can be deployed in a virtualized infrastructure. In particular embodiments, a VNF 534 may include one or more virtual machines 532 that collectively provide specific functionalities (e.g., wide area network (WAN) optimization, virtual private network (VPN) termination, firewall operations, load-balancing operations, security functions, etc.). A VNF 534 running on platform logic 510 may provide the same functionality as traditional network components implemented through dedicated hardware. For example, a VNF 534 may include components to perform any suitable NFV workloads, such as virtualized evolved packet core (vEPC) components, mobility management entities, 3rd Generation Partnership Project (3GPP) control and data plane components, etc.

SFC 536 is group of VNFs 534 organized as a chain to perform a series of operations, such as network packet processing operations. Service function chaining may provide the ability to define an ordered list of network services (e.g. firewalls, load balancers) that are stitched together in the network to create a service chain.

A hypervisor 520 (also known as a virtual machine monitor) may comprise logic to create and run guest systems 522. The hypervisor 520 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 510. Services of hypervisor 520 may be provided by virtualizing in software or through hardware assisted resources that require minimal software intervention, or both. Multiple instances of a variety of guest operating systems may be managed by the hypervisor 520. Each platform 502 may have a separate instantiation of a hypervisor 520.

Hypervisor 520 may be a native or bare-metal hypervisor that runs directly on platform logic 510 to control the platform logic and manage the guest operating systems. Alternatively, hypervisor 520 may be a hosted hypervisor that runs on a host operating system and abstracts the guest operating systems from the host operating system. Various embodiments may include one or more non-virtualized platforms 502, in which case any suitable characteristics or functions of hypervisor 520 described herein may apply to an operating system of the non-virtualized platform.

Hypervisor 520 may include a virtual switch 538 that may provide virtual switching and/or routing functions to virtual machines of guest systems 522. The virtual switch 538 may comprise a logical switching fabric that couples the vNICs of the virtual machines 532 to each other, thus creating a virtual network through which virtual machines may communicate with each other. Virtual switch 538 may also be coupled to one or more networks (e.g., network 508) via physical NICs of communication interface 518 so as to allow communication between virtual machines 532 and one or more network nodes external to platform 502 (e.g., a virtual machine running on a different platform 502 or a node that is coupled to platform 502 through the Internet or other network). Virtual switch 538 may comprise a software element that is executed using components of platform logic 510. In various embodiments, hypervisor 520 may be in communication with any suitable entity (e.g., a SDN controller) which may cause hypervisor 520 to reconfigure the parameters of virtual switch 538 in response to changing conditions in platform 502 (e.g., the addition or deletion of virtual machines 532 or identification of optimizations that may be made to enhance performance of the platform).

Hypervisor 520 may also include resource allocation logic 544 which may include logic for determining allocation of platform resources based on the telemetry data (which may include stress information). Resource allocation logic 544 may also include logic for communicating with various components of platform logic 510 entities of platform 502 to implement such optimization, such as components of platform logic 502. For example, resource allocation logic 544 may direct which hardware resources of platform logic 510 will be used to perform workloads based on stress information.

Any suitable logic may make one or more of these optimization decisions. For example, system management platform 506; resource allocation logic 544 of hypervisor 520 or other operating system; or other logic of platform 502 or computer platform 500 may be capable of making such decisions (either alone or in combination with other elements of the platform 502). In a particular embodiment, system management platform 506 may communicate (using in-band or out-of-band communication) with the hypervisor 520 to specify the optimizations that should be used in order to meet policies stored at the system management platform.

In various embodiments, the system management platform 506 may receive telemetry data from and manage workload placement across multiple platforms 502. The system management platform 506 may communicate with hypervisors 520 (e.g., in an out-of-band manner) or other operating systems of the various platforms 502 to implement workload placements directed by the system management platform.

The elements of platform logic 510 may be coupled together in any suitable manner. For example, a bus may couple any of the components together. A bus may include any known interconnect, such as a multidrop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the computer platform 500 may be coupled together in any suitable manner, such as through one or more networks 508. A network 508 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), intranet, extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 522 may communicate with nodes that are external to the computer platform 500 through network 508.

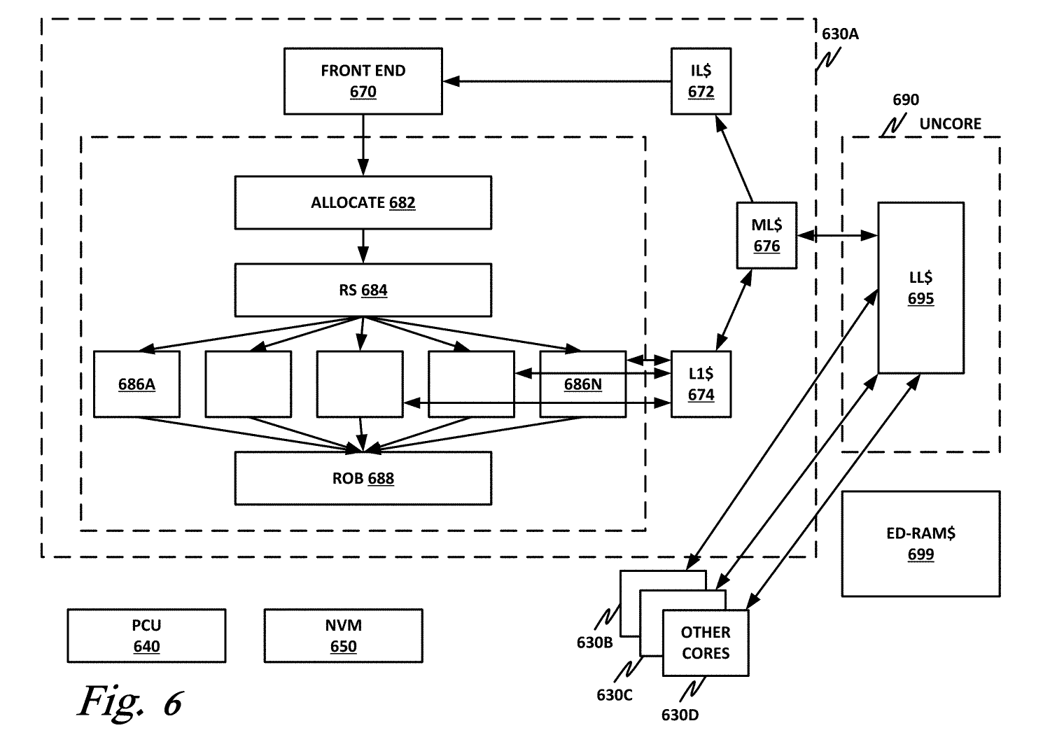

FIG. 6 illustrates a block diagram of a central processing unit (CPU) 612 in accordance with certain embodiments. Although CPU 612 depicts a particular configuration, the cores and other components of CPU 612 may be arranged in any suitable manner. CPU 612 may comprise any processor or processing device, such as a microprocessor, an embedded processor, a digital signal processor (DSP), a network processor, an application processor, a coprocessor, a system on a chip (SOC), or other device to execute code. CPU 612, in the depicted embodiment, includes four processing elements (cores 630 in the depicted embodiment), which may include asymmetric processing elements or symmetric processing elements. However, CPU 612 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 612 may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 630A includes an out-of-order processor that has a front end unit 670 used to fetch incoming instructions, perform various processing (e.g. caching, decoding, branch predicting, etc.) and passing instructions/operations along to an out-of-order (OOO) engine 680. OOO engine 680 performs further processing on decoded instructions.

A front end 670 may include a decode module coupled to fetch logic to decode fetched elements. Fetch logic, in one embodiment, includes individual sequencers associated with thread slots of cores 630. Usually a core 630 is associated with a first ISA, which defines/specifies instructions executable on core 630. Often machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. For example, decoders may, in one embodiment, include logic designed or adapted to recognize specific instructions, such as transactional instructions. As a result of the recognition by the decoders, the architecture of core 630 takes specific, predefined actions to perform tasks associated with the appropriate instruction. It is important to note that any of the tasks, blocks, operations, and methods described herein may be performed in response to single or multiple instructions; some of which may be new or old instructions. Decoders of cores 630, in one embodiment, recognize the same ISA (or a subset thereof). Alternatively, in a heterogeneous core environment, a decoder of one or more cores (e.g., core 630B) may recognize a second ISA (either a subset of the first ISA or a distinct ISA).

In the embodiment depicted, out-of-order engine 680 includes an allocate unit 682 to receive decoded instructions, which may be in the form of one or more micro-instructions or uops, from front end unit 670, and allocate them to appropriate resources such as registers and so forth. Next, the instructions are provided to a reservation station 684, which reserves resources and schedules them for execution on one of a plurality of execution units 686A-686N. Various types of execution units may be present, including, for example, arithmetic logic units (ALUs), load and store units, vector processing units (VPUs), floating point execution units, among others. Results from these different execution units are provided to a reorder buffer (ROB) 688, which take unordered results and return them to correct program order.

In the embodiment depicted, both front end unit 670 and out-of-order engine 680 are coupled to different levels of a memory hierarchy. Specifically shown is an instruction level cache 672, that in turn couples to a mid-level cache 676, that in turn couples to a last level cache 695. In one embodiment, last level cache 695 is implemented in an on-chip (sometimes referred to as uncore) unit 690. Uncore 690 may communicate with system memory 699, which, in the illustrated embodiment, is implemented via embedded dynamic random access memory (eDRAM). The various execution units 686 within out-of-order engine 680 are in communication with a first level cache 674 that also is in communication with mid-level cache 676. Additional cores 630B-630D may couple to last level cache 695 as well.

In various embodiments, uncore 690 (sometimes referred to as a system agent) may include any suitable logic that is not a part of core 630. For example, uncore 690 may include one or more of a last level cache, a cache controller, an on-die memory controller coupled to a system memory, a processor interconnect controller (e.g., an Ultra Path Interconnect or similar controller), an on-die IO controller, or other suitable on-die logic.

In particular embodiments, uncore 690 may be in a voltage domain and/or a frequency domain that is separate from voltage domains and/or frequency domains of the cores. That is, uncore 690 may be powered by a supply voltage that is different from the supply voltages used to power the cores and/or may operate at a frequency that is different from the operating frequencies of the cores.

CPU 612 may also include a power control unit (PCU) 640. In various embodiments, PCU 640 may control the supply voltages and the operating frequencies applied to each of the cores (on a per-core basis) and to the uncore. PCU 640 may also instruct a core or uncore to enter an idle state (where no voltage and clock are supplied) when not performing a workload.

In various embodiments, PCU 640 may detect one or more stress characteristics of a hardware resource, such as the cores and the uncore. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 640 may detect stress characteristics at any suitable interval.

In various embodiments, PCU 640 may comprise a microcontroller that executes embedded firmware to perform various operations associated with stress monitoring described herein. In one embodiment, PCU 640 performs some or all of the PCU functions described herein using hardware without executing software instructions. For example, PCU 640 may include fixed and/or programmable logic to perform the functions of the PCU.

In various embodiments, PCU 640 is a component that is discrete from the cores 630. In particular embodiments, PCU 640 runs at a clock frequency that is different from the clock frequencies used by cores 630. In some embodiments where PCU is a microcontroller, PCU 640 executes instructions according to an ISA that is different from an ISA used by cores 630.

In various embodiments, CPU 612 may also include a nonvolatile memory 650 to store stress information (such as stress characteristics, incremental stress values, accumulated stress values, stress accumulation rates, or other stress information) associated with cores 630 or uncore 690, such that when power is lost, the stress information is maintained.

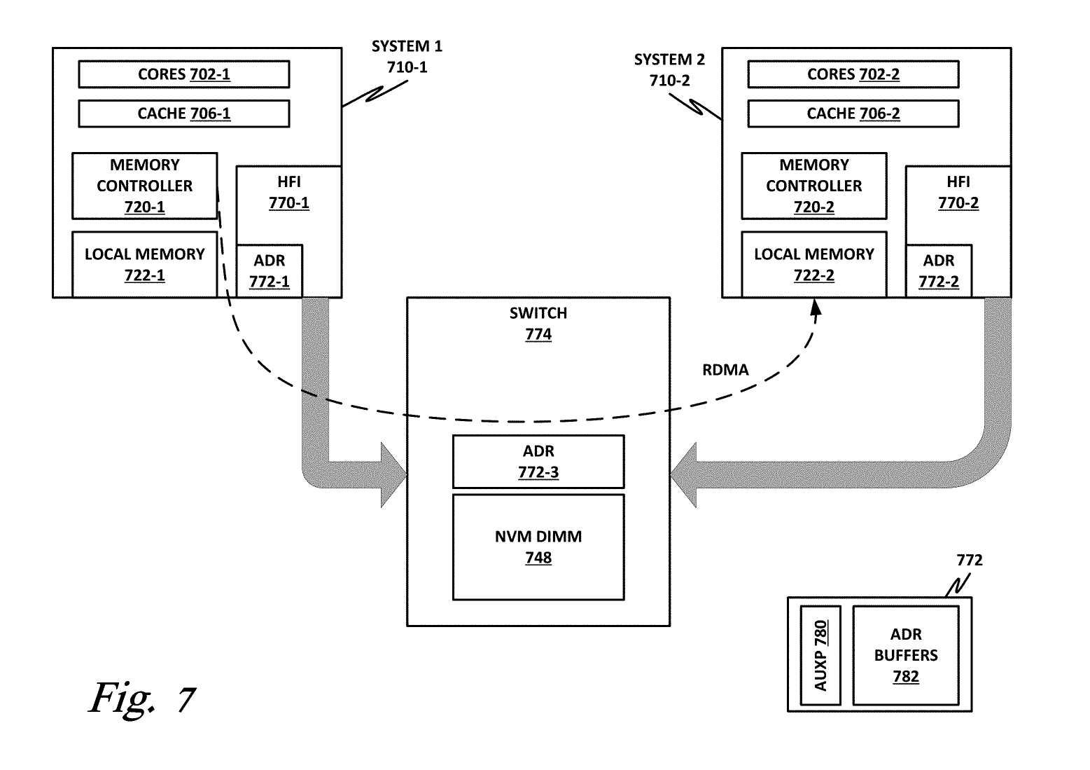

FIG. 7 is a block diagram of a datacenter configured for remote direct memory access (RDMA) and asynchronous data refresh (ADR) according to one or more examples of the present specification.

In this example, system 1 710-1 is connected to system 2 710-2 in an RDMA configuration via switch 774. The two systems may be peer systems in the datacenter, or system 2 may be, for example, a memory server providing remote access to memory such as 3DXP memory as described above. In this example, system 1 710-1 is accessing remote memory on system 2 710-2, though the system could just as easily work in reverse. In this particular example, system 2 provides a local memory 722-2, which may be a persistent fast memory. System 1 may also have a local memory 722-1, which may be a volatile memory, or which may be a persistent memory.

In the course of RDMA operation, system 1 710-1 issues store directives to its own local persistent memory 722-1. Two distinct volatile regions where the store could be situated before reaching memory are the cache hierarchy (shown as cache 706-1) and internal buffers of memory controller 720-1. For purposes of this specification, cache 706-1 and internal buffers of memory controller 720-1 may both be considered “volatile cache,” meaning that they are regions where data may be temporarily stored, and data stored there are lost when power is removed.

In normal operation, if the store is in cache 706, it can be flushed out by use of an instruction such as CLFLUSHOPT, along with a memory fence instruction such as SFENCE. Thus, issuing these two instructions can guarantee that the store is no longer in cache 706.

But after the store is flushed out from cache 706, it may still be situated in the memory controller buffers, which are also volatile. Thus, in the event of a power loss, it may be necessary to use ADR 772 to ensure that data are stored to persistent fast memory. As illustrated in the detail view of ADR 772, an auxiliary power 780 (such as a capacitor or small battery) is provided in conjunction with ADR buffers 782. Auxiliary power 780 is selected to have sufficient stored energy that in the case of a primary power failure or removal (e.g., catastrophic power loss, or a user-initiated or scheduled shutdown, suspend, or restart), there is sufficient power to flush data in the volatile caches to persistence. With this feature, application software can freely assume that all stores are persistent once executed.

But in the case of RDMA, the issue is more complicated. It is not sufficient for the local device to have the requisite power to manage its own storage. There may need to be a chain of powered devices to ensure that the data achieve persistence remotely. In the illustrated RDMA path (shown with a dashed line), an application on system 1 710-1 can issue “puts” or “stores” to system 2 710-2. When an application on system 1 710-1 issues a persistent store to system 2 710-2, the application can issue the CLFLUSHOPT and SFENCE to ensure the store is no longer in the CPU caches of system 1 710-1. Similarly, an ADR 770-2 on system 2 can handle a store residing in a volatile cache of system 2 710-2. But when power is removed, the store could still be situated in the HFI 770-1 of system 1 710-1, within the fabric itself (e.g., on switch 774), or within HFI 770-2 of system 2 710-2.

To ensure persistence, a mechanism provides software controls and visibility into persisting data while writing to persistent memory on a remote node. This may be considered “ADR over RDMA.” This mechanism includes the addition of capacitive power to cover the HFI (which may be integrated with the processor in some contemporary systems), addition of a persistent buffer in the switch, and new data flows.

In one example, there may be dedicated ADR channels within the fabric. These dedicated channels may be dedicated software channels or ports, or they may be dedicated hard-wired channels. These channels may be dedicated specifically to conveying remote memory stores with a guaranteed bandwidth.

Each HFI 770 includes an ADR 772, including an ADR buffer 782 sized according to the bandwidth of the dedicated ADR channels, so as to guarantee that remote persistent memory requests from node 1 710-1 to switch 774 arrive at switch ADR 772-3 in case of power failure. Once a store request arrives at switch 774, it is stored first in ADR 772-3, and then may be moved to an intermediate nonvolatile location, such as an NVM DIMM 748. From this point, the data may be sent to node 2 710-2 using regular channels and existing flows (including ADR 772-2 in node 2).

In certain embodiments, HA can be used to detect that a remote memory request targets a persistent fast memory. Once the remote persistent write is saved to ADR 772, an acknowledgement (ACK) may be sent back to the core and the application.

Further in certain embodiments, system 710 switch 774 may have one or more dedicated fabric channels, or a fixed guaranteed bandwidth, for remote writes. ADR 772 may be sized to ensure that ADR buffer 782 can be flushed to switch 774 in case of power failure.

Note that while ADR 772 ensures that RDMA requests can be flushed out in the case of a local power failure, a datacenter-wide power failure may cause the loss of “in-flight” data (e.g., still residing on the switch). Thus, the use of NVM DIMM 748 in conjunction with ADR 772-3 is provided to mitigate such losses. In one example, data are stored in NVM DIMM 748 for a few seconds while a larger auxiliary power source, such as a generator or uninterruptible power supply (UPC) takes over. Once operational power is restored, the data can then be sent from NVM DIMM 748 to system 2 710-2 in a seamless manner.

Once data are delivered to system 2 710-2, ADR 77202 can help to ensure that the data are stored persistently there, even in the case of a power loss.

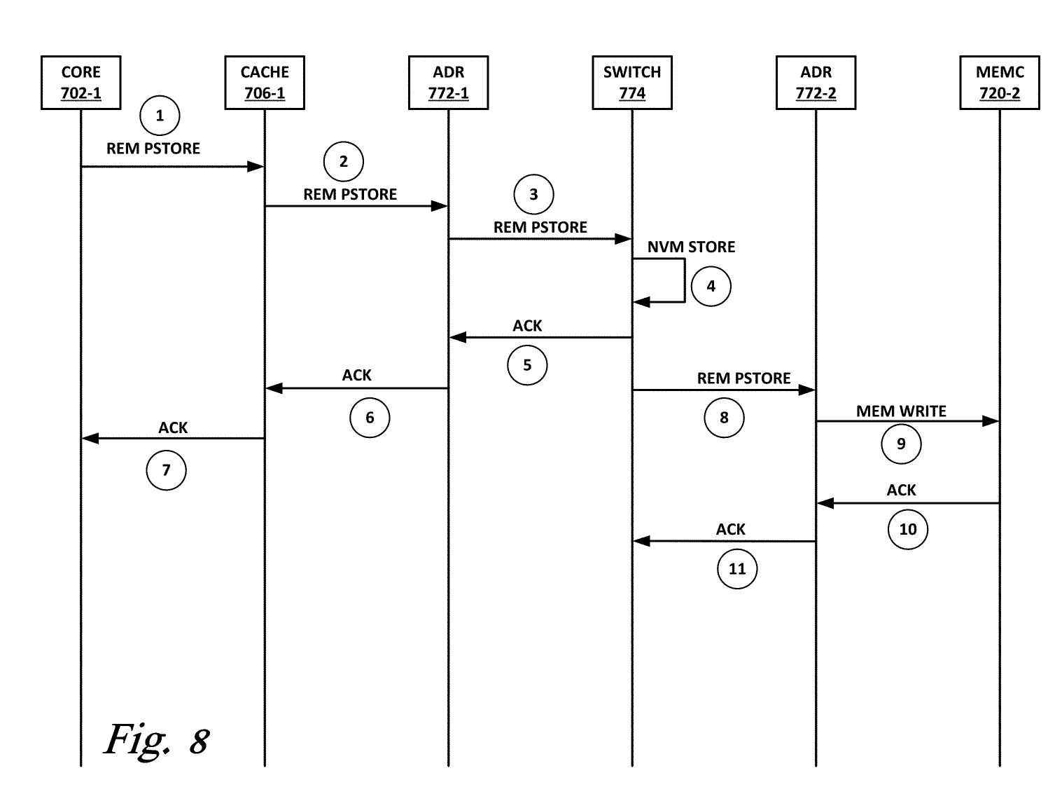

FIG. 8 is a signal flow diagram of an RDMA persistent store operation according to one or more examples of the present specification. This flow may be useful both in normal operation, and in the case of a power loss. In this example, core 702-1 of system 1 710-1 is executing a program and is using RDMA to access a remote persistent fast memory of system 2 710-2. Switch 774 provides a fabric between the two systems.

At operation 1, core 702-1 issues a remote persistent store instruction, which is directed to cache 706-1. Cache 706-1 may be a volatile cache, and thus may need to further propagate the data before persistence is achieved. Thus, at operation 2, cache 706-1 writes the data out to ADR 772-1 of system 1 710-1.

Once the data are written to ADR 772-1, at operation 3, ADR 772-1 issues the remote persistent store instruction to switch 774. At operation 4, switch 774 stores the data in NVM DIMM 748. Now from the perspective of system 1 710-1, the remote persistent store is successful. In other words, the data have been handed off to switch 774, and have achieved persistence within switch 774, so that ADR 772-1 has fulfilled its purpose.

When switch 774 has stored the data in NVM DIMM 748, it may issue an ACK to ADR 772-1 (operation 5), indicating that the data have achieved persistence. ADR 772-1 may then propagate the ACK to cache 706-1 (operation 6), and finally to core 702-1 (operation 7). Thus, from the perspective of system 1 710-1, the remote persistent store is successful.

In some embodiments, if core 702-1 fails to receive the appropriate ACKs, an exception may be thrown or some other remedial action may be taken.

Returning to switch 774, switch 774 must either retain the data in its own nonvolatile memory, or propagate the data out to system 2 710-2 and be satisfied that system to 710-2 has successfully stored the data. Thus, at operation 8, switch 774 propagates the remote persistent store out to system 2 710-2.

System 2 710-2 receives the remote persistent store into ADR 772-2. At operation 9, ADR 772-2 issues a memory write to memory controller 720-2. Once ADR 772 issues the memory write, memory controller 720-2 stores the data in persistent fast memory 722-2.

At operation 10, memory controller 720-2 sends an ACK to ADR 772-2. ADR 772-2 is now satisfied that the data have been successfully written to remote persistent memory, and at operation 11, ADR 772-2 issues an ACK to switch 774.

Once switch 774 has received the ACK from ADR 772-2, switch 774 is satisfied that the data have been persistently written, and normal operation may resume.

But if, for example, the power of ADR 772-2 fails before the persistent write is complete, then ADR 772-2 will not be able to send the ACK to switch 774. If switch 774 does not receive the ACK, then switch 774 maintains the data in its own persistent memory, such as NVM DIMM 748. When power is restored, switch 774 may take remedial action. For example, switch 774 may again try to write the data out to system 2 710-2, or in some cases, may provide a notification to a system administrator to alert the administrator of the failed system write. The system administrator may then take additional action.

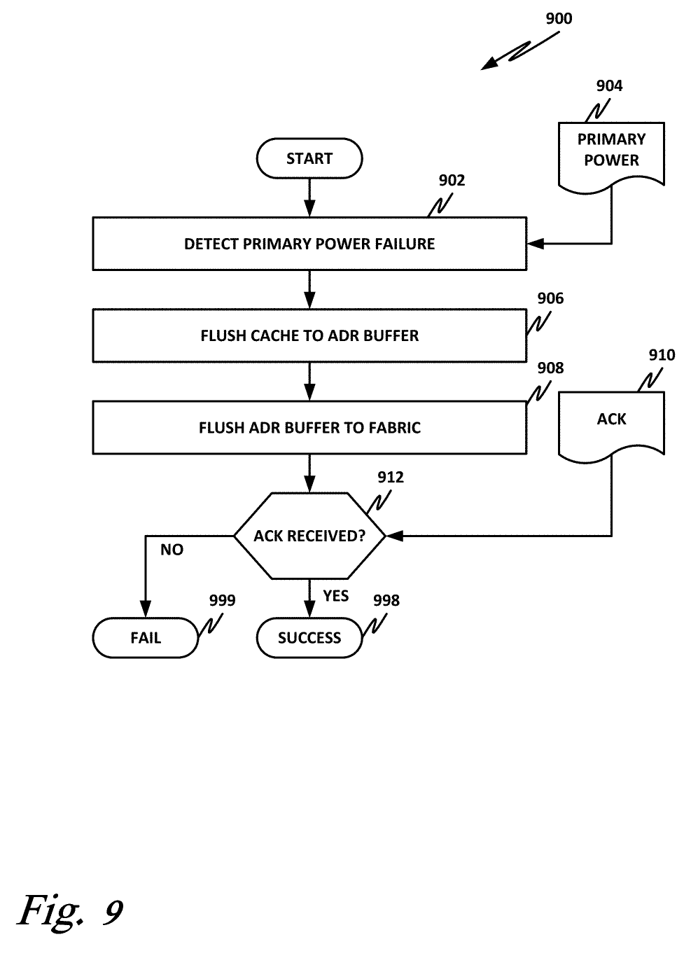

FIG. 9 is a flowchart of a method 900 performed by system 1 710-1 performing ADR over RDMA according to one or more examples of the present specification.

In block 902, primary power 904 fails or is removed, such as a reboot event, suspend, power outage, or from a catastrophic power failure. System 1 710-1 detects the primary power failure.

In block 906, system 1 710-1 flushes its volatile cache to ADR 772-1, which includes an ADR buffer 782 and auxiliary power 780.

In block 908, ADR 772-1 flushes the ADR buffer out to fabric 774 via HFI 770-1. System 1 710-1 then waits for an ACK from fabric 774.

In decision block 912, system 710-1 determines whether it has received an appropriate ACK 910 from fabric 774. If no ACK is received, then in block 999, the remote persistent memory write fails, and an exception may be raised or some remedial action may be taken.

On the other hand, if an ACK is received, then in block 998, from the perspective of system 1 710-1, the remote persistent memory write is successful.

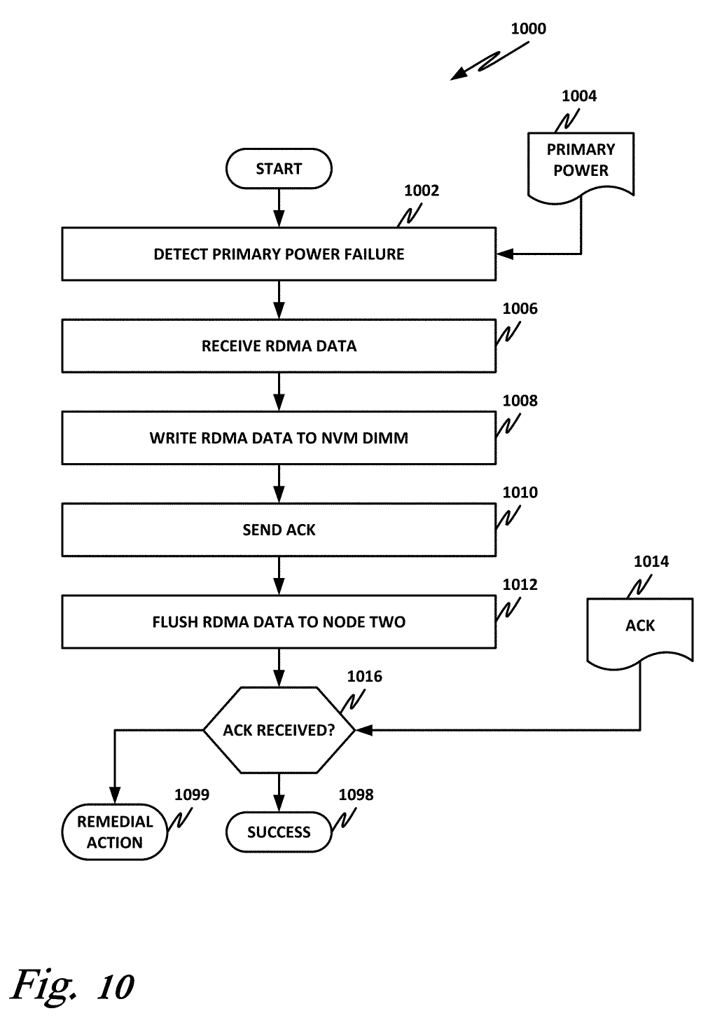

FIG. 10 is a flowchart of a method 1000 performed by switch 774 according to one or more examples of the present specification.

In block 1002, primary power 1004 fails as described above, and switch 774 detects the power failure, indicating that persistent data need to be preserved.

In block 1006, switch 774 receives RDMA data from system 1 710-1. These data are initially received into ADR 772-3 of switch 774.

In block 1008, switch 774 writes the RDMA data to NVM DIMM 748. This ensures that even if auxiliary power fails before the remote persistent write is complete, the data in NVM DIMM 748 will not be lost.

In block 1010, switch 774 sends an ACK to system 1 710-1, indicating to system 1 710-1 that the write is successful (from the perspective of system 1 710-1).

In block 1012, switch 774 flushes the RDMA data to node 2 710-2. Switch 774 then waits for an ACK from system to 710-2.

In decision block 1016, if ACK 1014 is not received, then in block 1099, the remote persistent store to system 2 710-2 has failed, and some remedial action may be taken as described above.

On the other hand, if ACK 1014 is received, then in block 1098, the store to system 2 710-2 is successful.

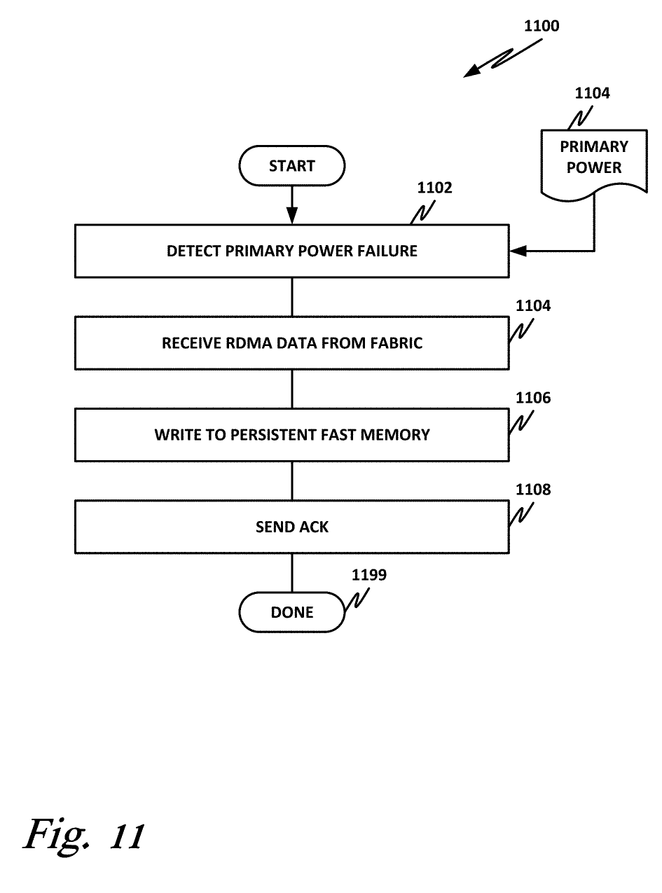

FIG. 11 is a flowchart of a method 1100 performed by system 2 710-2 according to one or more examples of the present specification.

In block 1102, system 2 710-2 detects a power failure of primary power 1104.

In block 1104, using auxiliary power within ADR 772-2, system 2 710-2 receives RDMA data from fabric 774.

In 1106, system 2 710-2 writes the data to its persistent fast memory 722-2.

In block 1108, once the data have been successfully written to persistent fast memory, system 2 710-2 sends an ACK to switch 774.

In block 1199, the method is done.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), field-programmable gate arrays (FPGAs), and other semiconductor chips.

Note also that in certain embodiments, some of the components may be omitted or consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field-programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, nontransitory storage medium (for example, random access memory (RAM), read only memory (ROM), field programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A nontransitory storage medium herein is expressly intended to include any nontransitory special-purpose or programmable hardware configured to provide the disclosed operations, or to cause a processor to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

There is disclosed in one example, a computing apparatus, comprising: a host fabric interface (HFI) for communicatively coupling to a fabric controller of a fabric; an asynchronous data refresh (ADR) comprising an auxiliary power and an ADR buffer; and a memory controller comprising logic to: directly access a persistent fast memory of a remote computing device via the fabric; detect a primary power failure event; and flush data from the ADR buffer to the fabric controller.

There is also disclosed an example, further comprising a cache, and wherein the memory controller is further to flush data from the cache to the ADR buffer.

There is also disclosed an example, wherein the memory controller logic is further to receive an acknowledgement (ACK) from the fabric controller.

There is also disclosed an example, wherein the memory controller logic is further to designate the data as successfully written.

There is also disclosed an example, further comprising a local persistent fast memory.

There is also disclosed an example, wherein the memory controller logic is further to: after detecting a primary power failure event, receive data from the fabric controller into the ADR buffer; and flush the ADR buffer to the persistent fast memory.

There is also disclosed an example, wherein the memory controller logic is further to send an acknowledgement to the fabric controller.

There is also disclosed an example, further comprising a dedicated ADR channel on the HFI.

There is also disclosed an example, wherein the dedicated ADR channel is a hardware channel.

There is also disclosed an example, wherein the dedicated ADR channel is a software channel.

There is also disclosed an example a persistent fast memory server, comprising: a host fabric interface (HFI) for communicatively coupling to a fabric controller of a fabric; a persistent fast memory; an asynchronous data refresh (ADR) comprising an auxiliary power and an ADR buffer; and a memory controller comprising logic to: provide remote direct memory access (RDMA) to a remote host via the fabric; detect a primary power failure event; receive data from the fabric controller into the ADR buffer; and flush the ADR buffer to the persistent fast memory

There is also disclosed an example, wherein the memory controller logic is further to send an acknowledgement to the fabric controller.

There is also disclosed an example, further comprising a dedicated ADR channel on the HFI.

There is also disclosed an example, wherein the dedicated ADR channel is a hardware channel.

There is also disclosed an example, wherein the dedicated ADR channel is a software channel.

There is also disclosed an example, wherein the memory controller logic is further to: directly access a persistent fast memory of a remote computing device via the fabric; and after detecting the remote power failure event, flush data from the ADR buffer to the fabric controller.

There is also disclosed an example, further comprising a cache, and wherein the memory controller is further to flush data from the cache to the ADR buffer.

There is also disclosed an example, wherein the memory controller logic is further to receive an acknowledgement (ACK) from the fabric controller.

There is also disclosed an example, wherein the memory controller logic is further to designate the data as successfully written.

There is also disclosed an example of a method of providing storage to a remote persistent fast memory, comprising: communicatively coupling to a fabric controller of a fabric; directly accessing a persistent fast memory of a remote computing device via the fabric, comprising writing data to a local asynchronous data refresh (ADR) buffer; detect a primary power failure event; accessing an auxiliary power; and flushing data from the ADR buffer to the fabric controller.

There is also disclosed an example, further comprising flushing data from a cache to the ADR buffer.

There is also disclosed an example, further comprising receiving an acknowledgement (ACK) from the fabric controller.

There is also disclosed an example, further comprising designating the data as successfully written.

There is also disclosed an example, further comprising accessing a local persistent fast memory.

There is also disclosed an example, further comprising: after detecting a primary power failure event, receiving data from the fabric controller into the ADR buffer; and flushing the ADR buffer to the persistent fast memory.

There is also disclosed an example, further comprising sending an acknowledgement to the fabric controller.

There is also disclosed an example, further comprising accessing a dedicated ADR channel on the fabric.

There is also disclosed an example, wherein the dedicated ADR channel is a hardware channel.

There is also disclosed an example, wherein the dedicated ADR channel is a software channel.

There is also disclosed an example of a network switch, comprising: a switching fabric to provided remote direct memory access (RDMA) from a first system to a second system, wherein the second system includes a persistent fast memory; an asynchronous data refresh (ADR) comprising an ADR buffer and an auxiliary power; and logic to: detect a primary power failure; receive RDMA data from the first system; and flush the RDMA data to the second system.

There is also disclosed an example, further comprising a local persistent memory, wherein receiving the RDMA data from the first system comprises receiving the RDMA data into the local persistent memory.

There is also disclosed an example, wherein the logic is further to send an acknowledgement to the first system.

There is also disclosed an example, wherein the logic is further to receive an acknowledgement from the second system.

There is also disclosed an example, wherein the logic is further to designate the RDMA data as successfully written.

There is also disclosed an example, wherein the logic is further to determine that no acknowledgement was received from the second system, and to take a remedial action.

What is claimed is:

1. A computing apparatus, comprising:
a host fabric interface (HFI) for communicatively coupling to a fabric controller of a fabric;
an asynchronous data refresh (ADR) comprising an auxiliary power and an ADR buffer; and
a memory controller comprising logic to:
directly access a persistent fast memory of a remote computing device via the fabric;
detect a primary power failure event; and
flush data from the ADR buffer to the fabric controller.

2. The computing apparatus of claim 1, further comprising a cache, and wherein the memory controller is further to flush data from the cache to the ADR buffer.

3. The computing apparatus of claim 1, wherein the memory controller logic is further to receive an acknowledgement (ACK) from the fabric controller.

4. The computing apparatus of claim 3, wherein the memory controller logic is further to designate the data as successfully written.

5. The computing apparatus of claim 1, further comprising a local persistent fast memory.

6. The computing apparatus of claim 5, wherein the memory controller logic is further to:
after detecting a primary power failure event, receive data from the fabric controller into the ADR buffer; and
flush the ADR buffer to the persistent fast memory.

7. The computing apparatus of claim 6, wherein the memory controller logic is further to send an acknowledgement to the fabric controller.

8. The computing apparatus of claim 1, further comprising a dedicated ADR channel on the HFI.

9. The computing apparatus of claim 8, wherein the dedicated ADR channel is a hardware channel.

10. The computing apparatus of claim 8, wherein the dedicated ADR channel is a software channel.

11. A persistent fast memory server, comprising:
a host fabric interface (HFI) for communicatively coupling to a fabric controller of a fabric;
a persistent fast memory;
an asynchronous data refresh (ADR) comprising an auxiliary power and an ADR buffer; and
a memory controller comprising logic to:
provide remote direct memory access (RDMA) to a remote host via the fabric;
detect a primary power failure event;
receive data from the fabric controller into the ADR buffer; and
flush the ADR buffer to the persistent fast memory

12. The computing apparatus of claim 11, wherein the memory controller logic is further to send an acknowledgement to the fabric controller.

13. The computing apparatus of claim 11, further comprising a dedicated ADR channel on the HFI.

14. The computing apparatus of claim 13, wherein the dedicated ADR channel is a hardware channel.

15. The computing apparatus of claim 13, wherein the dedicated ADR channel is a software channel.

16. The computing apparatus of claim 11, wherein the memory controller logic is further to:
directly access a persistent fast memory of a remote computing device via the fabric; and
after detecting the remote power failure event, flush data from the ADR buffer to the fabric controller.

17. The computing apparatus of claim 16, further comprising a cache, and wherein the memory controller is further to flush data from the cache to the ADR buffer.

18. The computing apparatus of claim 16, wherein the memory controller logic is further to receive an acknowledgement (ACK) from the fabric controller.

19. The computing apparatus of claim 18, wherein the memory controller logic is further to designate the data as successfully written.

20. A network switch, comprising:
a switching fabric to provided remote direct memory access (RDMA) from a first system to a second system, wherein the second system includes a persistent fast memory;
an asynchronous data refresh (ADR) comprising an ADR buffer and an auxiliary power; and
logic to:
detect a primary power failure;
receive RDMA data from the first system; and
flush the RDMA data to the second system.

21. The network switch of claim 20, further comprising a local persistent memory, wherein receiving the RDMA data from the first system comprises receiving the RDMA data into the local persistent memory.

22. The network switch of claim 21, wherein the logic is further to send an acknowledgement to the first system.

23. The network switch of claim 21, wherein the logic is further to receive an acknowledgement from the second system.

24. The network switch of claim 23, wherein the logic is further to designate the RDMA data as successfully written.

25. The network switch of claim 23, wherein the logic is further to determine that no acknowledgement was received from the second system, and to take a remedial action.
